(19) United States
(12) Patent Application Publication
(10) Pub. No.: US 2022/0017182 A1
(43) Pub. Date: Jan. 20, 2022

(54) SHIP HULL AIR MICROBUBBLE LUBRICATION SYSTEM

(71) Applicant: James Khreibani, Miami Beach, FL (US)

(72) Inventor: James Khreibani, Miami Beach, FL (US)

(21) Appl. No.: 16/930,207

(22) Filed: Jul. 15, 2020

(51) Int. Cl. B63B 1/38

(52) U.S. Cl. CPC B63B 1/38; B63B 2001/387

(57) ABSTRACT

This disclosure relates to a ship hull microbubble system used to reduce frictional drag on a ship hull while traveling through water. The microbubble system includes a water pump connected to an ejector which intern draws and compresses air within the ejector body. While in the ejector the compressed air becomes entrained within the pumped liquid as microbubbles creating a multiphase fluid which is then ejected at suitable pressure from the ship hull below the waterline through dedicated hull openings. The ejected air liquid multiphase fluid then creates plurality of microbubbles within the below water boundary layer reducing frictional drag generated by the hull as it travels through water. This disclosure has advantages when compared to related art through minimizing ship structure modifications, reducing wear on the ballast pump, operational autonomy from the ballast system, reducing the systems area footprint, independent control of the air injection rate, simplifying the installation through reducing existing pipework modifications and removing the need for riser pipes and additional tanks.

### CROSS-REFERENCE TO RELATED APPLICATIONS

This application claims the benefit of provisional patent application Ser. No. 62/675,722, filed 15 Jul. 2019 by the present inventor.

### FIELD OF THE INVENTION

This disclosure relates to a microbubble system used to reduce drag on a ship hull while traveling through water. The microbubble system includes a pump which discharges motive water through an ejector. The ejector then draws and compresses air within the throat and discharges air microbubbles entrained within the motive water creating a multiphase fluid. This microbubble fluid is discharged from the ship hull through dedicated hull openings located within the ship hull structure and below the waterline. The discharged fluid creates a plurality of microbubbles around the ship hull and reduce the density within the ships boundary layer therefore drag.

### BACKGROUND OF THE INVENTION

The following is a tabulation of related art that presently appears relevant:

U.S. Patents

| Pat. No. | Kind Code | Issue Date | Patentee |
|---|---|---|---|
| 10,315,729 | B2 | 2019 Jun. 11 | McPherson |

It is well known in the art that gas liquid ejectors can utilize a higher pressure liquid to pressurize a lower pressure gas into a gas liquid multiphase fluid with entrained microbubbles. It is also well known in the art that utilizing microbubbles ejected under the waterline and within the ship hull boundary layer will reduce the frictional drag as the vessel transits through the water. By way of example and without limitation this system is also known as air lubrication and generally performed with large capacity air compressors.

McPherson within U.S. Pat. No. 10,315,729 disclosed an air lubrication system which incorporates a ballast pump, mechanically coupled to a ballast main pipe and further connected to a forward peak tank with a forward peak tank valve. A venturi air injector is joined to the ballast main pipe with a riser pipe. The venturi then discharges liquid gas multiphase fluid from the bottom of the ship hull. However this disclosure has certain disadvantages. The specific need for a ballast pump will require the ballast water mainline to be modified to connect to the venturi which may be difficult depending on the location and distance the ballast water mainline is from both the venturi and microbubble discharge point on the ships hull. Additional issues include wear on the ballast water pump from continual operation required to create microbubbles where the ship ballast system is normally used infrequently while ballasting. The ballast system will also not function while the ballast pump is supplying water to the venturi which is connected to the ballast main pipe using a riser pipe traveling through multiple decks when installed on large vessels.

### BRIEF SUMMARY OF THE INVENTION

Generally stated this disclosure relates to a ship hull microbubble system used to reduce frictional drag on a ship hull while traveling through water. The disclosure includes a pump which discharges motive fluid to power an ejector which intern draws and compresses air within the ejector mixing throat. As the low pressure air enters the ejector throat it is compressed by the relatively high pressure liquid motive and becomes entrained within the liquid as microbubbles. The microbubble liquid multiphase fluid then exits the ejector where it is discharged into the ship boundary layer through dedicated hull openings located below the waterline and within the ship hull structure. The discharged ejector microbubble fluid then creates a plurality of microbubbles within the ships boundary layer reducing the frictional drag on the hull. This disclosure has advantages when compared to related art through minimizing ship structure modifications, reducing wear on the ballast pump, operational autonomy from the ballast system, reducing the systems area footprint, independent control of the air injection rate, simplified installation through reducing existing pipework modifications and removing the need for riser pipes and additional tanks.

### BRIEF DESCRIPTION OF THE DRAWINGS

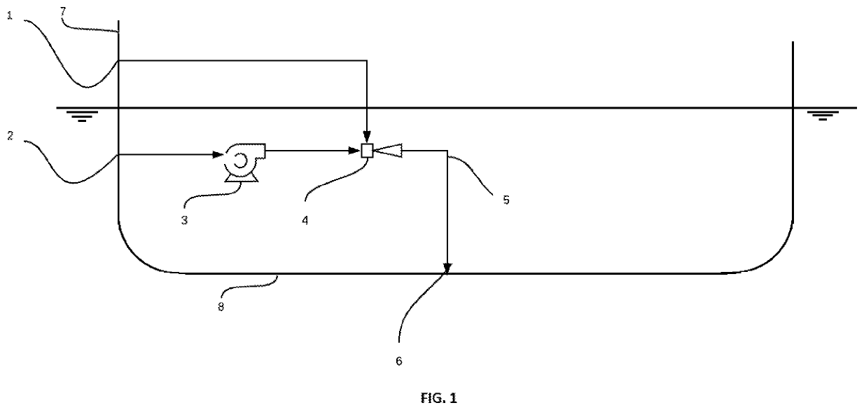

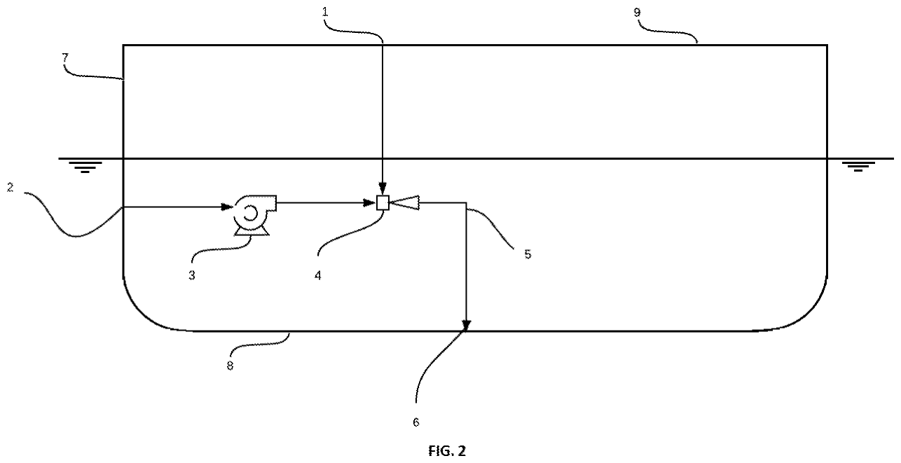

The various embodiments of this disclosure will be better understood by referring to the following detailed description and the accompanying drawings which illustrate the disclosed configurations. It should be understood that the system shown in FIGS. 1 and 2 may be implemented in various arrangements, with additional or reduced components.

FIG. 1 shows a ship cross section and flow diagram schematically illustrating the use of the disclosure with the ejector air intake penetrating the ship hull. The reference numerals represent the following:
1 Ejector air intake
2 Ejector water intake
3 Pump
4 Ejector
5 Ejector air microbubble liquid multiphase discharge
6 Microbubble hull ejection opening
7 Ship hull side
8 Ship hull bottom

FIG. 2 shows a ship cross section and flow diagram schematically illustrating the use of the disclosure with the ejector air intake penetrating the deck above the ship hull. The reference numerals represent the following:
1 Ejector air intake
2 Ejector water intake
3 Pump
4 Ejector
5 Ejector air microbubble liquid multiphase discharge
6 Microbubble hull ejection opening.
7 Ship hull side
8 Ship hull bottom
9 Deck above the ship hull

### DETAILED DESCRIPTION OF THE INVENTION

By way of example, and referring to FIG. 1, one embodiment of the disclosure comprises a ejector air intake (1) penetrating the side of the ship hull (7) above the waterline and mechanically coupled to a ejector (4). The term “mechanically coupled” may include by way of example and without limitation, combined into a single component during the original equipment manufacturers (OEM) process, pipework, ducting, flanges, fasteners and any combination of mechanically coupled devices that convey air or water. The term “ejector” refers to any device utilizing venturi principles to create air microbubbles within water for example and without limitation educator and jet pump. The ejector water intake (2) penetrates the ship hull side (7) or ship hull bottom (8) below the waterline and mechanically coupled to a pump (3). The pump (3) is mechanically coupled to the ejector (4) where the pump (3) pressurizes the water from the ejector water intake (2) and causes the ejector (4) to draw the required air from the ejector air intake (1) and create air microbubble entrained within water. The ejector (4) then discharges the air microbubble liquid multiphase flow (5) where the ejector (4) is mechanically coupled to a single or plurality of microbubble hull ejection opening (6). The microbubble flow (5) is then discharged through a single or plurality of microbubble hull ejection opening (6) located below the waterline and in the ship hull bottom (8). As the microbubble flow (5) exits through a single or plurality of microbubble hull ejection opening (6) and into the ship boundary layer the density of the boundary layer is reduced lowering the associated ship frictional drag. The density of an air microbubble relative to the water causes the air microbubbles to rise and remain in contact with the ship hull bottom (8) as the ship transits through the water. In another embodiment of the same invention detailed in FIG. 1, a single or plurality of microbubble hull ejection opening (6) are located in the ship hull side (7) reducing the friction drag generated by the hull side (7). In another embodiment of the same invention detailed in FIG. 1, microbubble hull ejection opening (6) are located in the ship hull side (7) and ship hull bottom (8) reducing the friction drag generated by the hull side (7) and hull bottom (8). In another embodiment of the same invention detailed in FIG. 1, the ejector water intake (2) penetrates the bow (not shown) or bulbous-bow (not shown) of the ship and mechanically coupled to the pump (3).

By way of example, and referring to FIG. 2, another embodiment of the disclosure comprises an ejector air intake (1) penetrating the deck above the ship hull (9) and mechanically coupled to the ejector (4). The ejector water intake (2) penetrates the ship hull side (7) or ship hull bottom (8) below the waterline and mechanically coupled to a pump (3). The pump (3) is mechanically coupled to the ejector (4) where the pump (3) pressurizes the water from the ejector water intake (2) and causes the ejector (4) to draw the required air from the ejector air intake (1) and create air microbubble entrained within water. The ejector (4) then discharges the air microbubble liquid multiphase flow (5) where the ejector (4) is mechanically coupled to a single or plurality of microbubble hull ejection opening (6). The microbubble flow (5) is then discharged through a single or plurality of microbubble hull ejection opening (6) located below the waterline and in the ship hull bottom (8). As the microbubble flow (5) exits through a single or plurality of microbubble hull ejection opening (6) and into the ship boundary layer the density of the boundary layer is reduced lowering the associated ship frictional drag. The density of an air microbubble relative to the water causes the air microbubbles to rise and remain in contact with the ship hull bottom (8) as the ship transits through the water. In another embodiment of the same invention detailed in FIG. 2, a single or plurality of microbubble hull ejection opening (6) are located in the ship hull side (7) reducing the friction drag generated by the hull side (7). In another embodiment of the same invention detailed in FIG. 2, microbubble hull ejection opening (6) are located in the ship hull side (7) and ship hull bottom (8) reducing the friction drag generated by the hull side (7) and hull bottom (8). In another embodiment of the same invention detailed in FIG. 2, the ejector water intake (2) penetrates the bow (not shown) or bulbous-bow (not shown) of the ship and mechanically coupled to the pump (3).

The advantages of the various embodiments within this disclosure include independent control of the air injection rate by adjusting the motive fluid flow rate through the pump while maintaining the ability to simultaneously ballast. Modifications to the ships existing machinery arrangement and wear on the ballast pump which is essential for safe operation will be significantly reduced.

I claim:

1. A method for reducing friction on a ship hull using microbubbles, comprising:
a. A water intake penetrating the ship hull and mechanically coupled to the pump,
b. A ejector mechanically coupled to said pump used to provide the motive fluid for said ejector to draw air,
c. A air supply intake penetrating the ship hull and mechanically coupled to said ejector to create air microbubbles,
d. A microbubble hull discharge opening penetrating a ship hull bottom and mechanically coupled to said ejector to release microbubbles into the ships boundary layer,

2. The method of claim 1 further including said microbubble hull ejection opening penetrating ship hull side.

3. The method of claim 1 whereby plurality of said microbubble hull ejection opening penetrates said ship hull side and said ship hull bottom.

4. The method of claim 1 whereby said air supply inlet pentation is mechanically coupled to a deck above said ship hull.

5. The method of claim 1 where said water intake penetrates a ship bow.

6. The method of claim 1 where said water intake penetrates a ship bulbous-bow.

7. The method of claim 1 whereby said air supply inlet is located within said ship hull drawing air from within said ship hull.
